(19) United States
(12) Patent Application Publication
(10) Pub. No.: US 2009/0094109 A1
(43) Pub. Date: Apr. 9, 2009

(54) Method and System for Providing Discounted Services to Customers

(75) Inventors: Jay A. Aaronson, North Easton, MA (US); Emanuel D. Torti, Norfolk, MA (US)

Correspondence Address: BRUCE E. HAYDEN, P.C., P.O. BOX 205, DILLION, CO, 80435-0205, US

(73) Assignee: WORLDWIDE SERVICECLUB, INC., a Massachusetts Corporation, Norfolk, MA (US)

(21) Appl. No.: 11/869,725

(22) Filed: Oct. 9, 2007

(51) Int. Cl. G06Q 30/00

(52) U.S. Cl. 705/14; 705/1; 705/37

(57) ABSTRACT

ServiceClub provides an efficient and economic way to connect sellers of services with potential buyers of their services. Discounts, coupons, and special promotions can be provided potential customers based on geographic considerations, so a potential customer can receive services of a specific type either around where he lives or works, or currently is located. Since the system provides geographic filtering, a national or international system can provide discounts and promotions local to a user. Customers benefit because of the national system, and service providers benefit through highly focused advertising.

### FIELD OF THE INVENTION

The present invention generally relates to a computer based system and method with electronic communications between potential buyers and sellers and, more specifically, to a services club for electronically providing advertising, promotional, and promotional materials to potential service users.

### BACKGROUND OF THE INVENTION

The World Wide Web (WWW) has turned out to be a very good way to sell goods. Many vendors have web sites from which customers can buy their products, and eBay provides an auction system that sells almost any imaginable legal good.

Services have been harder to sell on the WWW. For one thing, services are more likely to be local, for example, you cannot realistically ship washing your car across the country using Fedex or UPS. Rather, customers are most interested in car washes close to their homes or work. This is important since service businesses represent two thirds of the U.S. economy today, and all indications are that this disparity will continue to grow in the future.

One way to sell goods and services is through discounts. Currently, Web site discounts can generally be broken down into five categories: 1) printing of coupons, as is done at Couponbug.com; 2) rebate sites in which a buyer gets a small percentage rebate for a purchase, such as in ebates.com; (3) rewards credit cards in which the buyer gets a small kick back for each purchase, the Discover card was a first; 4) Buyers buy discounted gift certificates (Restaurants.com); and 5) rewards cards that offer points which are exchangeable for offerings with predetermined limits on exchange. One problem with these disparate solutions is that they again are aimed primarily at goods, not services, while services represent a substantial majority of our economy. These five solutions are disjointed and are not integrated wherein the users are required to spend significant amounts of time to benefit from the solutions. It is well known that frequent flier miles rewards often go unused. Also, the solutions are not tailored to the individual users needs, but are one size fits all. These five solutions also have no electronic intelligence capability wherein a users needs can be anticipated by the Service Providers in advance. There is a long felt need for an intelligent integrated system in which users can take advantage of promotional incentives and discounts based on their changing needs at any given time in their own life cycle.

Another problem is that the solutions are either from national or international companies that do not provide access to discounts from small companies and/or from local vendors. The problem with local sites is that they tend to be small and hard to find. Most services are local in nature. None of the solutions in the prior art provide buyers access to a multitude of services that can be utilized by them in serving their individual service needs worldwide.

### BRIEF SUMMARY OF THE INVENTION

ServiceClub provides an efficient and economic way to connect sellers of services with potential buyers of their services. Discounts, coupons, and special promotions can be provided potential customers based on geographic considerations, so a potential customer can receive services of a specific type either around where he lives or works, or currently is located. Since the system provides geographic filtering, a national or international system can provide discounts and promotions local to a user. Customers benefit because of the national system, and service providers benefit through highly focused advertising.

### BRIEF DESCRIPTION OF THE DRAWINGS

FIG. 1 is a block diagram illustrating one or more embodiments of the present invention; and

FIG. 2 is a block diagram illustrating a General Purpose Computer.

### DETAILED DESCRIPTION OF THE INVENTION

The present invention operates essentially as an aggregator of Service Providers that offer discounts to customers. Certain discounts are typically accessible to visitors for free and the more substantial discounts/features of the site are available to paying “Members”. Herein, “Seller” and “Service Provider” will be used interchangeably to identify providers of services. “User”, “Buyer”, and “Customer” will be used interchangeably to identify consumers of services. “ServiceClub” is a group of Service Providers and/or Members who have associated together to benefit from their association. “Members” are Users or Customers who have joined a ServiceClub. It should be noted that this terminology is purely for ease in describing the invention, and should not be understood as limiting it in any way.

“Service Provider Material” can be viewed as comprising “Advertising Material”, “Promotional Material”, and “Incentive Material”. “Advertising Material” includes sales information provided by a seller. “Promotional Material” includes information about a seller as provided by either the seller or a third party. “Incentive Material” and “Incentives” are sales incentives and include money savings opportunities for buyers, including, but not limited to discounts and coupons. Service Provider Materials can be provided in any medium or form, including, but not limited to: text and graphics delivered over the Internet; video; RSS feeds; CRT screen; telephone or mobile device screen display; or in any other tangible or intangible form. It should also be understood that these categories and their contents are illustrative and not exhaustive, that there is overlap between categories, and therefore that neither the categories nor their specific contents should be understood as limiting this invention in any way.

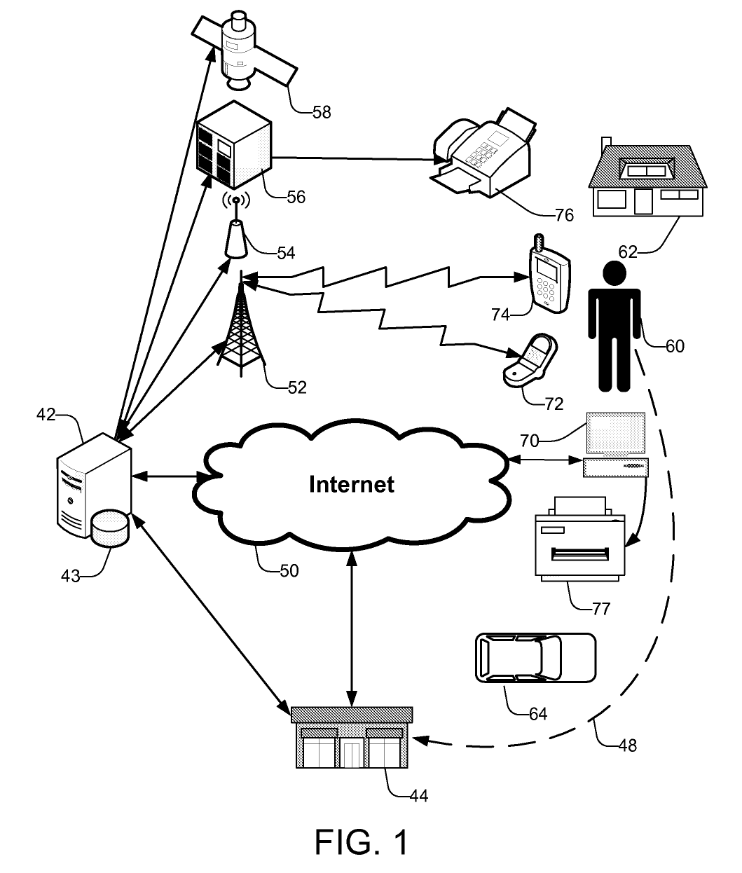

FIG. 1 is a block diagram illustrating one or more embodiments of the present invention. The ServiceClub system will typically reside in a server 42 connected to the Internet 50 and containing one or more databases 43. It receives specials, discounts, coupons, etc. from service providers 44 and transmits them to customers 60 for the service providers 44, in order to motivate potential buyers or customers 60 to utilize 48 the services of the service providers 44.

The ServiceClub system 42 is shown coupled to multiple communications media, including the Internet 50, cellular telephone towers 52, WiFi 54, telephone system 56, and satellites 58. This list is not exhaustive, but rather illustrative. Also, not every ServiceClub system 42 will be coupled to each of these communications media. Shown logically coupled to the Internet 50 is a computer 70 used by the customer 60 and the service provider 44. Shown logically coupled (typically through radio waves) to the cellular towers 52 are cellular telephones 72 and other remote devices 74 such as Blackberrys, PocketPCs, tablet PCs, etc. And note that many of these remote devices 74 can also be logically coupled to purely digital communications media, such as WiFi 54. Also, many of these devices can be coupled to the ServiceClub system 42 via satellite 58. As before, these methods of coupling various devices used by the customer 60 to the ServiceClub system 42 are illustrative only, and should not be considered exhaustive.

Also shown in this FIG. is a house 62 where the customer 60 typically resides, and an automobile 64 for his use. They are shown in order to indicate several locations for which coupons and special promotions may be provided to the customer 60 by the ServiceClub system 42. There is also a printer 77 shown coupled to the computer 70 and a FAX machine 76 coupled to the telephone system 56, both for printing out coupons.

Functionally, part of the invention can be viewed as Service Providers 44 providing material in the form of advertising, promotional, and incentive material to the ServiceClub system 42, where it is typically stored in a database 43. Service Providers 44 can specify the characteristics of their intended recipients of their material, and potential buyers 60 can specify what material they are willing or desire to receive. Thus, the potential service buyers 60 only receive material from service providers 44 when it has passed both service provider and their own filters. Also, two different methodologies are supported: push and pull. In the former, service providers 44 push material to potential buyers 60 willing to accept it. In the later, potential buyers 44 pull material from service providers 44 typically stored in a ServiceClub database 43. There may also be a combination of those two, when, for example, service provider material is pushed to potential buyers and then maintained in a database 43 on the server 42 for a period of time for receipt by (typically) other potential buyers.

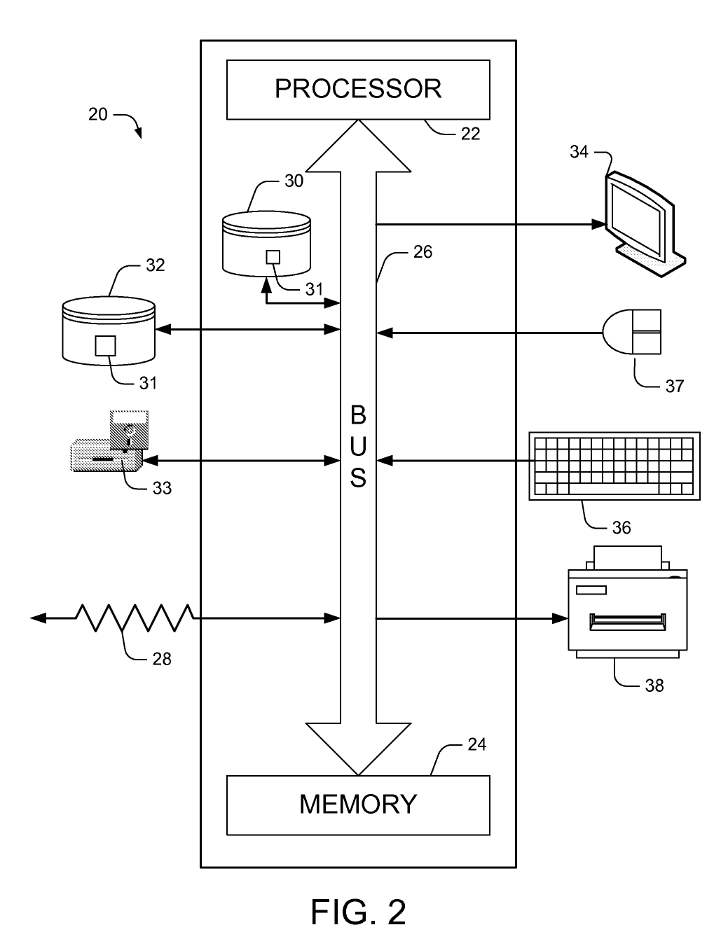

FIG. 2 is a block diagram illustrating a General Purpose Computer 20. The General Purpose Computer 20 has a Computer Processor 22, and Memory 24, connected by a Bus 26. Memory 24 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 30, External Storage 32, output devices such as a monitor 34, input devices such as a keyboard 36 and mouse 37, and printers 38. Secondary Storage 30 includes machine-readable media such as hard disk drives, magnetic drum, and bubble memory. External Storage 32 includes machine-readable media such as floppy disks 33, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such operating systems, finance, budgeting, and user programs as well as user data can be stored in a Computer Software Storage Medium, such as memory 24, Secondary Storage 30, and External Storage 32. Executable versions of computer software 31, such as browser, operating system, and ServiceClub operating software can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

ServiceClub is an online computer system and method for fulfilling the needs of buyers and sellers of services in a synergistic, win-win manner. The service needs of Users, whether they be income tax preparation, lawn mowing, automobile repair, or any other service, are fulfilled with convenience and with discounts. It can provide one stop shopping for all things service related to users. Through ServiceClub, users can be provided the right services at the right price in the right location, and the price can be made even better through targeted discounts, promotions, and coupons. ServiceClub members will typically receive better discounts than will mere visitors to the ServiceClub site. There is a long felt need to bring purchasing power to individuals and small businesses for the purpose of services and related products. Individuals and business can gain the advantage of the combined purchasing power of all ServiceClub Users and Members like a cooperative. This allows them to purchase goods and services at a lower cost.

Service Providers can gain some or all of the following benefits by participating in ServiceClub:

Gain immediate access to an enormous base of motivated buyers

Build their brand in a crowded marketplace

Increase their revenue

Improved profits due to lower customer acquisition cost

Build customer satisfaction and long-term customer relationships

Gain marketing intelligence by testing price points and incentives

Generate employee goodwill by offering free SERVICECLUB.COM memberships

There is a long felt need for Service Providers to have more control over their customer acquisition costs. The Service Providers get immediate access to customers at a price potentially far less than their customary acquisition costs, as they define the discounts that are offered to customers. Service Providers can anticipate the needs of Users with a multitude of variables, including but not limited to usage on the site, geographies, demographics, and user preferences and can tailor offerings to Users based on those anticipated needs. Users can communicate needs, and the terms and conditions of those needs whereby Service Providers can decide if they can fulfill those needs or desires to submit a bid according to the terms and conditions as specified by potential customers.

An additional feature of the ServiceClub system is to provide an additional win-win feature to Users and Service Providers by making the system self perpetuating by having means for Users and Service Providers to earn commission on sales or referrals of paying Members and Service Providers' (Affiliates). Affiliates can be individuals, members of a group, associations, franchises, profit or not-for-profit organizations and entities. The Affiliate organization can put a link to the ServiceClub on its web site, in email, etc., and whenever someone clicks through to the ServiceClub using that link, the organization benefits when an individual or entity becomes a paying Member or Service Provider. Since the Affiliate program has the potential to minimize the need for ServiceClub to spend large sums of money on expensive advertising, the need to expose the site to banner ads (as is customary) to generate money is minimized or eliminated.

The Affiliate Program has three significant aspects: (A) A Service Provider can offer ServiceClub Memberships to employees at discounted Membership rates by passing along the Affiliate commissions by waiving receipt of those commissions, thereby allowing employees to join at the Member Rate less the Affiliate commission. (B) A Member can refer-third parties and get an Affiliate commission when those referred third parties join. The Member can then take the Affiliate commission as a cash payment, or use it to be applied to Member fees, or apply it to IRA's or debt payments or donate them to charity or otherwise direct the payment anywhere they want. (C) An organization or charity or trade organization can become an Affiliate to earn money for their organization, charity or trade organization by promoting ServiceClub to their own members. Any customers that join as Members or Service Providers would cause their organization, charity or trade organization to earn an Affiliate commission. Also, as in the Affiliate Program, the organization, charity or trade organization can waive their Affiliate Commission or donate the money to other charity's, etc. For example, a business can waive the fees for a period of time and donate the money to favorite charity or charities.

Service Providers can take advantage of the cooperative features of ServiceClub by sharing marketing other costs, such as the group purchasing of Google Ad Words and the sharing of those costs for words in their own category. Thus, Ad Words can be shared among Service Providers. They can also be purchased at a discount per Service Provider. The resulting saving can enable Service Providers to afford to buy more Ad Words for a given marketing budget.

Service Providers can immediately and at a low cost test difference promotions by merely making changes to their offering on the ServiceClub system. The promotions can be different in different locations/demographics at the same time. Service Providers with multiple locations can directly test different promotions at little to no cost (other than the cost of the discounts) simultaneously. In addition, Service Providers and Members will typically have a feedback loop whereby Service Providers can get feedback about the satisfaction of a Member using a Service Provider and the future needs of Members. Service Providers can improve services and/or devise more services based on real time feedback from Members.

One aspect of the present invention is that it can provide an online venue for eager buyers 60 and sellers 44 of services. It preferably provides a virtual service management system and apparatus in which the service needs of individuals and businesses are addressed on multiple levels on the site. Multiple features for the management of services from both the buyer and seller point of view are addressed by the invention. Some of these features include: ease of navigation, accumulation, cost savings for both buyers and sellers, service calendaring, scheduling and monitoring (with alerts), means for allowing customers to earmark cost savings and to have them paid directly to third parties, including savings for retirement via IRA's, or college savings, or debt management (such as credit card or mortgage principal reduction.) or for charitable contributions. The ServiceClub system 42 may also have a decision tree algorithm to help a customer to decide if they should take a discount now or save it for later and where to best put the money saved (e.g. IRA or credit card principal payment). No similar invention does all of the above in one system.

A further aspect of the present invention is the integration of ServiceClub with different media platforms such as Internet 50, cable (not shown), satellite 58, wireless 54, cellular 52, and telephonic 56 devices.

A further aspect of the present invention is the ability to have two (2) way communications via mobile devices such as mobile phones 72 and other mobile devices 74 whereby Service Providers 44 can broadcast special promotions to cell phones 72 and other mobile devices 74 to users in a prescribed geographic locations. For example, a car wash may offer special discounts during a slow time whereby the offers are broadcast to users 60 in the pertinent geographic area. (i.e. $10 off a car wash today from 6 to 7 pm, and broadcast that over the website and transmitted to all user cell phones in the same zip code, city, and town). In addition, a user can use their cell phone 72 or other mobile device 74 to retrieve information about discounts and special promotions in a given geographic are at a specific time.

A further aspect of the present invention is the ability to have alerts whereby users 60 can request and receive discount information over cell phones 72 and other mobile devices 74 and may specify the conditions for which they are alerted.

A further aspect of the present invention is to have the ability to provide communications means via global positioning systems (GPS) whereby Service Providers 44 can alert all ServiceClub Members within a certain geographic area that a special promotion is occurring at a particular time. Example: In a slow time, a car wash can transmit a special promotion for the next 2 hours to all ServiceClub Members within 2 miles, via cell phone and transmittal over the web by email alert.

Different strategies can be implemented, depending on the circumstances. For example, a user 60 can register his home 62 or work (not shown) zip code, and get alerts for special promotions or coupons sent to him via the Internet 50, a cell phone 72, or other mobile devices 74 for specials in that zip code. Alternatively, most cell phones 72 today have built in GPS, which can be used to locate the user 60. He can then get special promotions or coupons for specials within a certain radius of his current location (or, in this case, the location of his cell phone 72). As before, they can be transmitted to him via the Internet 50, or directly to his phone 72 or other mobile device 74. Thus, the user 60 can receive coupons, notices of promotions, etc. for locations near where he is currently located, such as when he is driving around in his automobile 64. For example, he might receive a notice of a short term special at a car wash near where he is currently driving, and noticing that his automobile is dirty, avail himself of that service.

Conventional businesses often generate customers by advertising or offering some form of discount. The customer acquisition cost is often very high and often unquantifiable, as the impact on sales of various advertising campaigns is often unknown. One advantage of the present invention is that it provides a directly quantifiable means in which a service provider (Seller) 44 gets to measure the cost (customer acquisition cost) of attracting new customers (Buyers) 60. It also benefits customers 60 by providing them substantial discounts by using service providers 44 through the ServiceClub system 42.

Users 60 may print 76, 77 coupons that can be scanned by the Service Providers 44. The coupons can be individually tailored and generated in order to identify both the customer 60 and the medium he received the coupon over. Other techniques are available with cellular phones 72 and other mobile devices 74. For example, a coupon can be individually tailored and generated for display, and that can be scanned by the Service Provider 44. Alternatively, the cellular phones 72 or other mobile devices 74 can communicate directly with the Service Provider 44 electronically, using for example BlueTooth or WiFi technologies, or using some frequency of light, such as infrared. Such communications can provide information to the Service Provider 44 indicating the origin of the discount, as well as authorizing the discount in the first place. In short, using the equivalent of an electronic coupon. The above list of alternatives is illustrative only, and should not be understood as being exhaustive.

A further aspect of the present invention is the ability to capture member usage data, preferences and other information about Users and Service Providers in a database for data mining. This data can be accessible to advertisers whereby advertisers can take the usage data and provide members with more targeted advertisements on other media platforms. For example, ServiceClub usage data may indicate that a substantial number of auto repair coupons are downloaded by a user 60. This information can then be used to offer targeted offers to that user 60 on ServiceClub 42 and through other media platforms, such as cable TV.

Another aspect of the present invention is the ability to “Data Mine”. A Service Provider 44 can mine discount usage data, user provided data, and other information to determine appropriateness and need a User 60 has for certain services (and products). This information can then be used to offer targeted advertising over the Internet and other media platforms. For example, if a User 60 is printing discounts on Elder Services, then a Service

Provider 44 (or another advertiser (for a fee perhaps)) can then target Advertising for services (and products) relevant to people with Elders. For example, once a User 60 of discounts on Elder Services is determined, then advertisers can pinpoint advertising to other elder related services and products such as chair lifts, vans with lifts, geriatric drugs, etc. This targeted advertising can be offered over numerous media platforms in addition to the internet, such as phone, direct mail and over cable TV ads to the Users home directly.

One expansion of data mining is Life Cycle of Service Needs. Service Providers can project the future service needs of a User based on a multitude of variables, including but not limited to usage on the site, geographies, demographics, and user preferences. Service Providers can then use this data to offer more deals to Members based on station in life, etc. Members can also dictate the type of deals and category of deals that they would want to receive future promotions about. For example, Service Providers can project when an Member is going off warranty with a car; Service Providers can anticipate services for children X number of years after service discounts for a wedding were downloading. In another example, child care services businesses can offer discounts a certain number (e.g. 4.2) of years after coupons for wedding planners and caterers were downloaded on the assumption that some of those getting married will now be having children. Service Providers can also use Data from this to send offers and/or bid against other Service Providers for the projected service needs.

In operation, a Buyer 60 can search for the needed service (Ex: Auto Lube). They will see that a discount is available for (Example $10.00). They can accept the discount and download a certificate for $10 that they will bring to the service provider 44 and get the $10 discount or they can pay the current price, and forfeit the $10 savings at the time of purchase. The $10 savings that was forfeited at the time of purchase because the customer elected to pay the current undiscounted rate can then be directed for payment to a third party of the customers choosing (such as a direct payment to their IRA or mortgage principal). The customer 60 pays the same amount that they would have paid without the discount so they do not feel the impact of the money that they saved. It is in essence, painless savings for a society whose failure to save and is over extended with debt is well known. The decision of whether or not a person should take the immediate discount or to earmark it for either debt reduction or future retirement or college savings, will be assisted with a decision algorithm, should they choose to use it. It will also calculate the rate of growth for the various options over time. When one IRA is sent the limit of the allowable contribution, the customer is informed that it has reached (or is reaching) the limit for the year and to seek alternative repositories for the accumulated discounts. An example would be to fund a spouses IRA after one IRA reaches the contribution limits.

One additional feature is to have a loyalty/rewards program for customers of the site so that they can accumulate rewards for use on the site and for use or trading with other third party rewards programs. Service Providers 44 can then sponsor rewards or matching rewards for those that fit certain criteria advantageous to the service provider. For example, a mutual fund company might match rewards for customers that opened IRA's with them or the mutual fund company makes a significant contribution to a spousal IRA after a customer has fully funded their own IRA with forfeited current saving discounts.

Service Providers 44 can utilize the site to trade other rewards program points such as frequent flyer miles and exchange them with customers or other service providers.

The invention is useful as a vehicle for Service Providers 44 to test market various incentive programs and to make immediate changes to them thereby optimizing the marketing return on investment.

Another aspect of this invention is that Members can dictate the Terms and Conditions of their needs in addition to merely price (like Priceline) and Service Providers can respond with whether they can fulfill those needs. For example, a user can ask which Service Provider can work on his car after 8 pm Monday through Wednesday nights?

Another aspect of the invention is a Service Registry. It is somewhat similar to a wedding registry, except for services. Members can register for services that they are interested in. One example would be registration for a retirement party, where the retiring worker makes requests for leisure services (golf and dance lessons, etc.), in addition to wedding, baby, birthday, house warming etc. Data mining (above) can mine needs data for further refinement of the data pertaining to the needs of the Member.

Another aspect of the invention is the ability to provide Service Bundles: Service Providers can cooperate in offering complimentary service discounts to Members based on usage data or otherwise. For example, a lawn care provider, plus a window washing provider plus gutter cleaning provider, etc. provide a bundled service. The Users can either buy the entire bundle, or can get a discount if more than one service in the bundle is purchased.

A ServiceClub site can have an educational and community function whereby Service Provider and Members can share information about services from a User and Provider point of view. Just as Wikipedia is a free content encyclopedia that is edited by users, ServiceClub can provide information about services provided by users and Service Providers. Other methods of sharing information between Service Providers and Members are also within the scope of this invention.

Another aspect of the invention is the system's ability to enable Users to purchase discounts directly as a percentage of the face value of the discount thereby eliminating the need of Users to join ServiceClub to gain access to all discounts.

The invention is essentially a win-win to both service providers 44 and customers 60. It saves each time, money and more like no other venue.

Those skilled in the art will recognize that modifications and variations can be made without departing from the spirit of the invention. Therefore, it is intended that this invention encompass all such variations and modifications as fall within the scope of the appended claims.

What is claimed is:

1. A computer implemented system for matching potential buyers with service providers through a service club, comprising:
a means for accepting service provider material from a service provider, wherein the service provider material comprises at least one of: advertising material, promotional material, and incentive material;
a means for selecting a subset of potential buyers from a set of potential buyers for receiving the service provider material from the service provider; and
a means for transmitting the service provider material to the subset of potential buyers.

2. The computer implemented system in claim 1 wherein:
the means for transmitting is capable of transmitting the service provider material to a remote device of one of the subset of potential buyers.

3. The computer implemented system in claim 1 wherein:
the means for selecting the subset of potential buyers utilizes a buyer filter for each of the set of potential buyers, wherein the buyer filter for a potential buyer filters out unwanted service provider material from service providers.

4. The computer implemented system in claim 3 which further comprises:
a means for accepting information from a potential buyer for use in specifying the buyer filter for the potential buyer.

5. The computer implemented system in claim 1 wherein:
the means for selecting the subset of potential buyers utilizes a service provider material filter for the service provider material, wherein the service provider material filter for the service provider information filters out unwanted buyers from the set of potential buyers.

6. The computer implemented system in claim 5 which further comprises:
a means for accepting information from the service provider for use in specifying the service provider material filter.

7. The computer implemented system in claim 5 wherein:
the means for selecting the subset of potential buyers further utilizes a buyer filter for each of the set of potential buyers, wherein the buyer filter for a potential buyer filters out unwanted service provider material from service providers.

8. The computer implemented system in claim 1 wherein:
the subset of potential buyers is limited to service club members.

9. The computer implemented system in claim 1 wherein:
the service provider material comprises time limited promotions for transmission to the subset of potential buyers selected based on their proximity to the service provider at a time of transmission.

10. The computer implemented system in claim 1 which further comprises:
a means for bundling a plurality of services as a bundle of services wherein a cost of the bundle of services is lower than a sum of a cost of the each of the plurality of services individually.

11. The computer implemented system in claim 1 which further comprises:
a means for paying a discount for a service purchased by a buyer to a third party.

12. The computer implemented system in claim 1 wherein:
the service club provides an ability for a group of buyers to obtain a lower cost when purchasing a service from the service provider.

13. The computer implemented system in claim 1 which further comprises:
a means to capture information about a service buying behavior of a set of buyers in a database, wherein the database is capable of being data mined in order to provide targeted marketing to the set of buyers.

14. The computer implemented system in claim 13 which further comprises:
a means for predicting future lifestyle needs of a buyer utilizing the database.

15. The computer implemented system in claim 1 which further comprises:
a means for a buyer of a service to provide a set of terms and conditions to a plurality of sellers of the service; and
a means for at least one of the plurality of sellers to provide the buyer with a bid on the terms and conditions at which the at least one of the plurality of sellers would be willing to provide the service to the buyer.

16. The computer implemented system in claim 1 which further comprises:
a means for a plurality of service providers to collectively share advertising resources.

17. The computer implemented system in claim 1 which further comprises:
a service registry for registering service interests of buyers.

18. The computer implemented system in claim 1 which further comprises:
a means for providing an affiliate program.

19. The computer implemented system in claim 18 wherein:
the affiliate program allows a service provider to offer service club memberships to employees of the service provider at a discounted cost.

20. The computer implemented system in claim 18 wherein:
the affiliate program allows a member to refer a third party to the service club, whereby the member gains an affiliate commission.

21. The computer implemented system in claim 1 wherein:
the service club material comprises an incentive;
the system further comprises:
a means for accepting a payment for the incentive for the benefit of a potential buyer; and
the means for selecting the subset of potential buyers requires that the payment be accepted for the benefit of the potential buyer as a condition for selecting the potential buyer as one of the subset of potential buyers to whom the incentive is transmitted.

22. A computer implemented method of matching potential buyers with service providers through a service club, comprising:
accepting service provider material from a service provider, wherein the service provider material comprises at least one of: advertising material, promotional material, and incentive material;
selecting a subset of potential buyers from a set of members of a service club for receiving the service provider material from the service provider; and
transmitting the service provider material to the subset of potential buyers.

23. A computer software storage medium containing software for matching potential buyers with service providers through a service club, wherein the software comprises:
a set of computer instructions for accepting service provider material from a service provider, wherein the service provider material comprises at least one of: advertising material, promotional material, and incentive material;
a set of computer instructions for selecting a subset of potential buyers from a set of potential buyers for receiving the service provider material from the service provider; and
a set of computer instructions for transmitting the service provider material to the subset of potential buyers.

24. A computer implemented system for matching potential buyers with service providers through a service club, comprising:
a database for storage of service provider material, wherein the service provider material comprises at least one of: advertising material, promotional material, and incentive material;
a means for accepting buyer information from a potential buyer in order to specify a buyer filter for the potential buyer;
a means of selecting service provider material from the database as selected service provider material for transmission to the potential buyer utilizing the buyer filter for the potential buyer; and
a means for transmitting the selected service provider material to the potential buyer.

25. A computer implemented system for matching potential buyers with service providers through a service club, comprising:
a means for accepting information about a first party to a potential transaction, wherein the first party is a first one of a set comprising: a potential buyer and a potential service provider;
a means of selecting the information for transmission to a second party as selected information, wherein the second party is a second one of the set comprising: the potential buyer and the potential service provider; and
a means of transmitting the selected information to the second party.
